(19) United States
(12) Patent Application Publication
(10) Pub. No.: US 2014/0084708 A1
(43) Pub. Date: Mar. 27, 2014

(54) DATA TRANSMITTING METHOD, DATA TRANSMITTING APPARATUS, AND ENERGY STORAGE SYSTEM INCLUDING THE SAME

(71) Applicant: Han-Seok Yun, Yongin-si (KR)

(72) Inventor: Han-Seok Yun, Yongin-si (KR)

(21) Appl. No.: 14/119,188

(22) PCT Filed: Aug. 8, 2012
(86) PCT No.: PCT/KR2012/006313

§ 371 Date: Nov. 20, 2013

Related U.S. Application Data
(60) Provisional application No. 61/530,713, filed on Sep. 2, 2011.

(51) Int. Cl. H02J 4/00

(52) U.S. Cl. CPC H02J 4/00
USPC 307/150

(57) ABSTRACT

An energy storage system configured to be coupled to at least one of a power generation system, a grid, or a load, and including a battery system including a system bus, a system controller coupled to the system bus and configured to transmit one or more first system frames, each of the first system frames including a command, and one or more battery racks coupled to the system bus and configured to transmit one or more second system frames, wherein at least one of the battery racks includes a rack for storing power, and a rack controller for receiving rack data and for transmitting the one or more second system frames, each of the second system frames including the command and at least a portion of the rack data, wherein at least one of the one or more second system frames further includes a second system frame counter.

### CROSS-REFERENCE TO A RELATED APPLICATION

This application is a National Phase Patent Application of International Patent Application Number PCT/KR2012/006313, filed on Aug. 8, 2012, which claims priority of U.S. Patent Application No. 61/530,713, filed on Sep. 2, 2011.

### BACKGROUND

1. Field

One or more embodiments of the present invention relate to a data transmitting method, a data transmitting apparatus, and an energy storage system including the data transmitting apparatus.

2. Description of the Related Art

As destruction of environment and depletion of resources are becoming serious, interest in systems for storing energy and efficiently using the stored energy is increasing. Furthermore, interest in new renewable energy, which does not generate pollution, or generates little pollution during a power generation process, is also increasing. An energy storage system may be a system that links such new renewable energy, a battery system for storing power, and an existing grid, and is being studied and developed according to environmental changes.

A battery system of such an energy storage system may be variously designed according to an amount of power to be supplied to a load. The battery system may store power by receiving power from outside the energy storage system, and may supply the stored power from the energy storage system. In other words, the battery system may perform charging and discharging operations.

The battery system monitors an internal state for stable operation, and gathers data measured via the monitoring. Here, the battery system includes various battery management units having a master-slave structure. The battery management units corresponding to slaves transmit the measured data to the battery management unit corresponding to a master, and the battery management unit corresponding to the master receives and gathers the measured data.

### DISCLOSURE

### Technical Problem

Aspects of embodiments of the present invention include a data transmitting method and a data transmitting apparatus that prevent error generation while transmitting data in an energy storage system, and an energy storage system including the data transmitting apparatus.

### Technical Solution

According to one or more of the embodiments of the present invention, error generation can be prevented while transmitting data.

An embodiment of the present invention provides an energy storage system configured to be coupled to at least one of a power generation system, a grid, or a load, the energy storage system including a battery system including a system bus, a system controller coupled to the system bus and configured to transmit one or more first system frames on the system bus, each of the first system frames including a command, and one or more battery racks coupled to the system bus and configured to transmit one or more second system frames on the system bus, wherein at least one of the one or more battery racks includes a rack for storing power, and a rack controller for receiving rack data, and for transmitting the one or more second system frames including the rack data on the system bus, each of the second system frames including the command and at least a portion of the rack data, wherein at least one of the one or more second system frames further includes a second system frame counter.

When a size of the rack data is larger than a system frame reference size, the rack data may be divided and included in two or more of the second system frames.

The system controller may be configured to operate as a master on the system bus, and the rack controller may be configured to operate as a slave on the system bus.

The system controller may be configured to command transmission of the rack data to the rack controller by transmitting at least one of the first system frames on the system bus.

The rack controller may be configured to transmit the rack data to the system controller by transmitting one or more of the second system frames on the system bus.

A communication protocol between the system controller and the rack controller of the at least one of the one or more battery racks may be a controller area network (CAN) protocol.

The at least one of the one or more battery racks may further include a rack bus and one or more battery trays for storing the power, at least one of the one or more battery trays may be coupled to the rack controller through the rack bus.

The at least one of the one or more battery trays may include a tray including one or more battery cells for storing the power, and a tray controller for controlling charging and discharging operations of the tray and for transmitting to the rack controller tray data including at least one of a measured temperature, a measured voltage, or a measured current of the one or more battery cells.

The rack controller may be configured to operate as a master on the rack bus, and the tray controller may be configured to operate as a slave on the rack bus.

The rack controller may be configured to transmit one or more first rack frames on the rack bus, and the tray controller may be configured to transmit one or more second rack frames on the rack bus.

The rack controller may be configured to command transmission of the tray data to the tray controller by transmitting at least one of the first rack frames including a command on the rack bus.

The tray controller may be configured to transmit the tray data to the rack controller by transmitting one or more of the second rack frames on the rack bus, each of the second rack frames including the command and at least a portion of the tray data, and at least one of the one or more second rack frames may further include a second rack frame counter.

When a size of the tray data is larger than a rack frame reference size, the tray data may be divided and included in two or more of the second rack frames.

A communication protocol between the rack controller and the tray controller of the at least one of the one or more battery trays may be a controller area network (CAN) protocol.

Another embodiment of the present invention provides a battery rack including a rack for storing power, a rack bus, and a rack controller coupled to the rack bus and configured to transmit one or more command frames on the rack bus, each of the command frames including a command, wherein the rack includes one or more battery trays for storing the power, at least one of the one or more battery trays including a tray including one or more battery cells for storing the power, and a tray controller coupled to the rack bus and configured to transmit to the rack controller one or more data frames including tray data including at least one of a measured temperature, a measured voltage, or a measured current of the one or more battery cells, wherein at least one of the data frames further includes a data frame counter.

When a size of the tray data is larger than a rack frame reference size, the tray data may be divided and included in two or more of the data frames.

The rack controller may be configured to operate as a master on the rack bus, and the tray controller may be configured to operate as a slave on the rack bus.

The rack controller may be configured to command the tray controller to transmit the tray data by transmitting one or more command frames including a command on the rack bus.

The tray controller may be configured to transmit the tray data to the rack controller by transmitting one or more data frames including the command and the tray data on the rack bus.

Yet another embodiment of the present invention provides a communication system for an energy storage system, the communication system having a master-slave structure and including a system bus, a master for transmitting on the system bus a command frame including a command, and for performing processing corresponding to data frames including the command and energy storage system data, and a plurality of slaves for receiving the command frame from the system bus, for performing an operation corresponding to the command in the command frame, and for transmitting the data frames on the system bus, wherein at least one of the data frames further includes a data frame counter.

When a size of the energy storage system data is larger than a reference size, the energy storage system data may be divided as data fragments and respectively included in two or more of the data frames.

Each of the data frames may include a plurality of data sections, the command and the data frame counter may be included in a same one of the data sections when a number of available commands is not greater than a reference number, and the command and the data frame counter may be included in different ones of the data sections when the number of the available commands is greater than the reference number.

The master may be configured to distinguish between the data frames based on the data frame counter.

### Advantageous Effects

Aspects of embodiments of the present invention include a data transmitting method and a data transmitting apparatus that prevent error generation while transmitting data in an energy storage system, and an energy storage system including the data transmitting apparatus.

### BRIEF DESCRIPTION OF THE DRAWINGS

These and/or other aspects will become apparent and more readily appreciated from the following description of the embodiments, taken in conjunction with the accompanying drawings, of which:

FIG. 1 is a block diagram of an energy storage system according to an embodiment of the present invention;

FIG. 2 is a block diagram of a battery system according to an embodiment of the present invention;

FIG. 3 is a block diagram of a battery rack according to an embodiment of the present invention;

FIG. 4 is a block diagram of a communication system having a master-slave structure;

FIG. 5 is a diagram of a frame structure of a controller area network (CAN) communication protocol;

FIG. 6 is a diagram of a data structure of transmitted data, according to an embodiment of the present invention;

FIG. 7 is a diagram of a data structure of transmitted data, according to another embodiment of the present invention;

FIG. 8 is a diagram of a data structure of transmitted data, according to another embodiment of the present invention;

FIG. 9 is a flowchart illustrating a data transmitting method of a communication system, according to an embodiment of the present invention;

FIG. 10 is a flowchart illustrating operations of a master, according to an embodiment of the present invention;

FIG. 11 is a diagram of a data structure of transmitted data, according to another embodiment of the present invention; and

FIG. 12 is a flowchart illustrating a data transmitting method of a communication system, according to another embodiment of the present invention.

### BEST MODE

An embodiment of the present invention provides an energy storage system configured to be coupled to at least one of a power generation system, a grid, or a load, the energy storage system including a battery system including a system bus, a system controller coupled to the system bus and configured to transmit one or more first system frames on the system bus, each of the first system frames including a command, and one or more battery racks coupled to the system bus and configured to transmit one or more second system frames on the system bus, wherein at least one of the one or more battery racks includes a rack for storing power, and a rack controller for receiving rack data, and for transmitting the one or more second system frames including the rack data on the system bus, each of the second system frames including the command and at least a portion of the rack data, wherein at least one of the one or more second system frames further includes a second system frame counter.

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

The terms used in the present specification are used to describe particular embodiments of the present invention, and are not intended to limit the present invention. An expression used in the singular encompasses the expression of the plural, unless it has a clearly different meaning in the context. In the present specification, it is to be understood that the terms such as “comprising,” “including,” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Hereinafter, embodiments of the invention will be described below in more detail with reference to the accompanying drawings. Those components that are the same or are in correspondence are indicated by the same reference numeral regardless of the figure number, and redundant explanations are omitted.

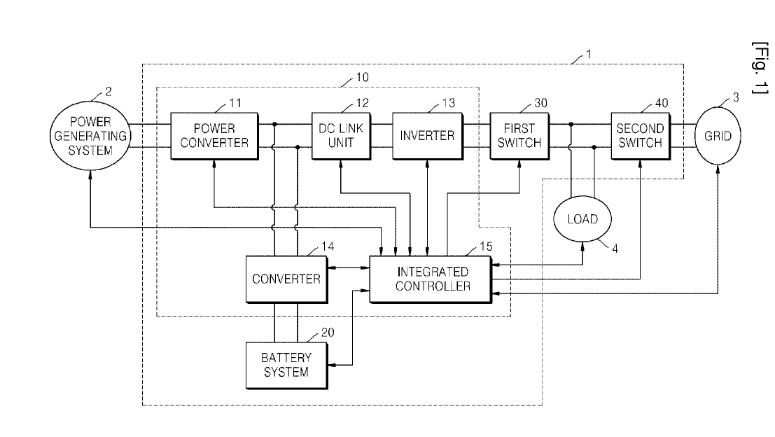

FIG. 1 is a block diagram of an energy storage system 1 according to an embodiment of the present invention.

Referring to FIG. 1, the energy storage system 1 according to the current embodiment supplies power to a load 4 in connection with a power generating system 2 and a grid 3.

The power generating system 2 is a system for generating power by using an energy source. The power generating system 2 may be a solar-light power generation system, a wind power generation system, or a tidal power generation system. However, the power generating system 2 is not limited to those listed above, and may be any power generation system for generating power by using new renewable energy, such as solar heat or geothermal heat. Specifically, a solar cell for generating electric power using sunlight is easily installed in homes or in factories, and thus, is suitable for the energy storage system 1 distributed in homes or in factories. The power generating system 2 includes a plurality of power generation modules arranged in parallel and generates power according to the power generation modules, thereby forming a high capacity energy system.

The grid 3 includes a power plant, a substation, and a power cable. When the grid 3 is in a normal state, the grid 3 supplies power to the energy storage system 1 to supply power to the load 4 and/or a battery system 20, and receives power from the energy storage system 1. When the grid 3 is in an abnormal state, power supplied from the grid 3 to the energy storage system 1 is stopped, and power supplied from the energy storage system 1 to the grid 3 is also stopped.

The load 4 consumes power generated by the power generating system 2, power stored in the battery system 20, or power supplied from the grid 3. Examples of the load 4 include a home or a factory.

The energy storage system 1 may store power generated by the power generating system 2 in the battery system 20, and may supply the generated power to the grid 3. The energy storage system 1 may supply power stored in the battery system 20 to the grid 3, or may store power supplied from the grid 3 in the battery system 20. Also, when the grid 3 is in an abnormal state, for example, when there is a blackout, the energy storage system 1 may supply power to the load 4 by performing an uninterruptible power supply (UPS) operation. The energy storage system 1 may supply the power generated by the power generating system 2 or the power stored in the battery system 20 even when the grid 3 is in a normal state.

The energy storage system 1 includes: a power conversion system (PCS) 10 for controlling power conversion; the battery system 20; a first switch 30; and a second switch 40.

The PCS 10 converts power of the power generating system 2, the grid 3, and the battery system 20 to appropriate power and supplies the appropriate power to where it is needed. The PCS 10 includes a power converter 11, a direct current (DC) link unit 12, an inverter 13, a converter 14, and an integrated controller 15.

The power converter 11 is a power conversion device connected between the power generating system 2 and the DC link unit 12. The power converter 11 transmits power generated by the power generating system 2 to the DC link unit 12, and at this time, converts an output voltage to a DC link voltage.

The power converter 11 may include a power conversion circuit, such as a rectifier circuit or a converter, according to a type of the power generating system 2.

When power generated by the power generating system 2 is a DC voltage, the power converter 11 may be a converter for converting a DC voltage to the DC link voltage. When power generated by the power generating system 2 is an alternating current (AC) voltage, the power converter 11 may be a rectifier circuit for converting an AC voltage to the DC voltage. Specifically, when the power generating system 2 is a solar light generation system, the power converter 11 may include a maximum power point tracking (MPPT) converter for performing MPPT control so that power generated by the power generating system 2 is improved or maximized according to solar radiation and temperature. When the power generating system 2 does not generate power, the power converter 11 may stop operating to reduce power consumed by the converter or the like.

A size of a DC link voltage may be unstable due to an instantaneous voltage drop in the power generating system 2 or the grid 3 or a peak load in the load 4. However, the DC link voltage needs to be stabilized for normal operations of the converter 14 and the inverter 13. The DC link unit 12 is connected between the power converter 11 and the inverter 13 to maintain constant the DC link voltage. An example of the DC link unit 12 includes a high capacity capacitor.

The inverter 13 is a power conversion device connected between the DC link unit 12 and the first switch 30. The inverter 13 may convert and output the DC link voltage output from the power generating system 2 and/or battery system 20 to an AC voltage of the grid 3, in a discharge mode. Also, the inverter 13 may include a rectifier circuit for rectifying the AC voltage of the grid 3 and for converting and outputting the rectified AC voltage to the DC link voltage so as to store power of the grid 3 in the battery system 20, in a charge mode. Alternatively, the inverter 13 may be a bidirectional inverter whose input and output directions are changeable.

The inverter 13 may include a filter for removing harmonic waves from an AC voltage output to the grid 3. In order to suppress reactive power from being generated, the inverter 13 may include a phase-locked loop (PLL) circuit for synchronizing a phase of the AC voltage output from the inverter 13 and a phase of an AC voltage of the grid 3. In addition, the inverter 13 may perform functions such as limiting voltage regulation, improving a power factor, removing a DC component, and protecting from transient phenomena. When the inverter 13 is not used, the inverter 13 may stop operating to reduce power consumption.

The converter 14 is a power conversion device connected between the DC link unit 12 and the battery system 20. The converter 14 includes a converter for DC-DC converting and outputting power stored in the battery system 20 to a voltage level required by the inverter 13, i.e., the DC link voltage, in a discharge mode. Also, the converter 14 includes a converter for DC-DC converting power output from the power converter 11 or from the inverter 13 to a voltage level required by the battery system 20 (i.e., a charge voltage) in a charge mode. Alternatively, the converter 14 may be a bidirectional converter whose input and output directions are changeable. The converter 14 may stop operating when the battery system 20 is not required to be charged or discharged, so as to reduce power consumption.

The integrated controller 15 monitors states of the power generating system 2, the grid 3, the battery system 20, and the load 4, and controls operations of the power converter 11, the inverter 13, the converter 14, the battery system 20, the first switch 30, and the second switch 40 according to the monitoring results and predetermined algorithms. The integrated controller 15 may monitor whether there is a blackout in the grid 3, whether power is generated by the power generating system 2, an amount of generated power if the power generating system 2 generates power, a charged state of the battery system 20, power consumption of the load 4, and time. Also, if power to be supplied to the load 4 is insufficient, for example, if there is a blackout in the grid 3, the integrated controller 15 may prioritize devices using power included in the load 4, and may control the load 4 to supply power to the devices according to the priority.

The first switch 30 and the second switch 40 are connected in series between the inverter 13 and the grid 3, and are turned on or off according to control of the integrated controller 15 to control current flow between the power generating system 2 and the grid 3. The first and second switches 30 and 40 may be turned on or off according to states of the power generating system 2, the grid 3, and the battery system 20.

In detail, the first switch 30 is turned on when power of the power generating system 2 and/or battery system 20 is supplied to the load 4 or when power of the grid 3 is supplied to the battery system 20. The second switch 40 is turned on when power of the power generating system 2 and/or battery system 20 is supplied to the grid 3 or when power of the grid 3 is supplied to the load 4 and/or battery system 20.

Meanwhile, when there is a black out in the grid 3, the second switch 40 is turned off and the first switch 30 is turned on. In other words, power of the power generating system 2 and/or battery system 20 is concurrently (e.g., simultaneously) supplied to the load 4 while power supplied to the load 4 is blocked from flowing toward the grid 3. Accordingly, islanding (e.g., continued supplying of power) of the energy storage system 1 is prevented, thereby preventing an accident, such as a worker working on a power line of the grid 3 being electrocuted by power from the energy storage system 1.

The first and second switches 40 may each be a switching device, such as a relay capable of withstanding a high current.

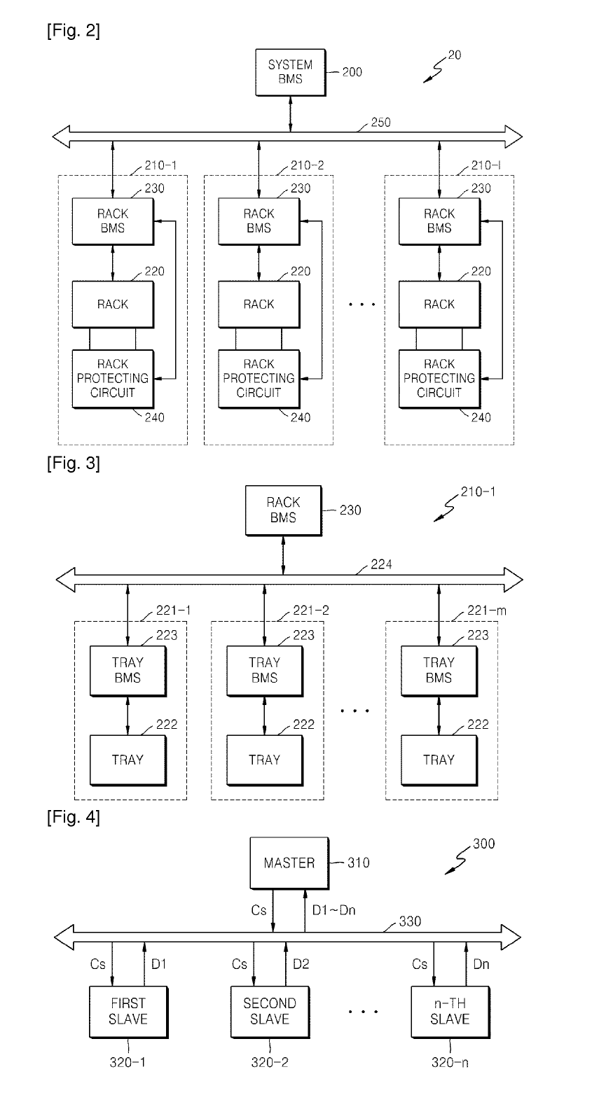

The battery system 20 receives and stores power of the power generating system 2 and/or grid 3, and supplies the stored power to the load 4 or the grid 3. The battery system 20 may include a part for storing power and a part for controlling and protecting the part for storing power. The battery system 20 will now be described in detail with reference to FIG. 2.

FIG. 2 is a block diagram of the battery system 20 according to an embodiment of the present invention.

Referring to FIG. 2, the battery system 20 includes first through I-th battery racks 210-1 through 210-1, a system controller (e.g., a system battery management system (BMS)) 200, and a first bus line 250 for data communication.

The first through I-th battery racks 210-1 through 210-I store power supplied from the outside (i.e., from the power generating system 2 and/or the grid 3) and supply the stored power to the grid 3 and/or load 4. The first through I-th battery racks 210-1 through 210-I may each include a rack 220, a rack controller (e.g., a rack BMS) 230, and a rack protecting circuit 240.

The rack 220 may include a tray 222 (FIG. 3) constituting a subcomponent where power is stored. The rack 220 is charged or discharged by the rack controller 230. The racks 220 may be connected in series or in parallel according to a required output voltage.

The rack controller 230 controls charging and discharging operations of the rack 220 by controlling the rack protecting circuit 240. Also, the rack controller 230 monitors a state, such as a temperature, a voltage, and a flowing current, of the rack 220, and transmits results of the monitoring to the system controller 200.

The rack protecting circuit 240 may block power supply according to control of the rack controller 230. Also, the rack protecting circuit 240 may measure a voltage and current of the rack 220 and transmit the measured voltage and current to the rack controller 230.

The first bus line 250 is a path for transmitting data or a command between the system controller 200 and the rack controller 230. A controller area network (CAN) communication protocol may be used as a communication protocol between the system controller 200 and the rack controller 230. However, the communication protocol is not limited thereto, and any communication protocol for transmitting data or a command by using a bus line may be used.

The first battery rack 210-1 will now be described in detail.

FIG. 3 is a block diagram of the first battery rack 210-1 according to an embodiment of the present invention.

Referring to FIG. 3, the first battery rack 210-1 includes first through m-th battery trays 221-1 through 221-m, the rack controller 230, and a second bus line 224 for data communication. Also, the first battery rack 210-1 may include the rack protecting circuit 240, which is not shown in FIG. 3.

The first through m-th battery trays 221-1 through 221-m are subcomponents of a rack, and thus store power and supply the stored power to the grid 3 and the load 4. Each of the first through m-th battery trays 221-1 through 221-m may include the tray 222 and a tray controller (e.g., a tray battery management system (BMS)) 223.

The tray 222 is where power is stored, and may include a battery cell as a subcomponent. A number of battery cells included in the tray 222 may be determined according to a required output voltage. Any chargeable secondary battery may be used as the battery cell. For example, a secondary battery used as the battery cell may be a nickel-cadmium battery, a lead battery, a nickel metal hydride battery (NiMH), a lithium ion battery, or a lithium polymer battery.

Charging and discharging operations of the tray 222 are controlled by the tray controller 223.

The tray controller 223 controls the charging and discharging operations of the tray 222. Also, the tray controller 223 monitors a state, such as a temperature, a voltage, or a flowing current, of the tray 222, and transmits results of the monitoring to the rack controller 230.

The second bus line 224 is a path for transmitting data or a command between the rack controller 230 and the tray controller 223. A CAN communication protocol may be used as a communication protocol between the rack controller 230 and the tray controller 223. However, the communication protocol is not limited thereto, and any communication protocol for transmitting data or a command by using a bus line may be used.

Meanwhile, in embodiments of the present invention, the communication protocols between the system controller 200 and the rack controller 230, and between the rack controller 230 and the tray controller 223, both use a bus line, but the embodiments are not limited thereto as long as one of the communications uses a communication protocol using a bus line.

Hereinafter, the structures described with reference to FIGS. 2 and 3 will be generalized and described.

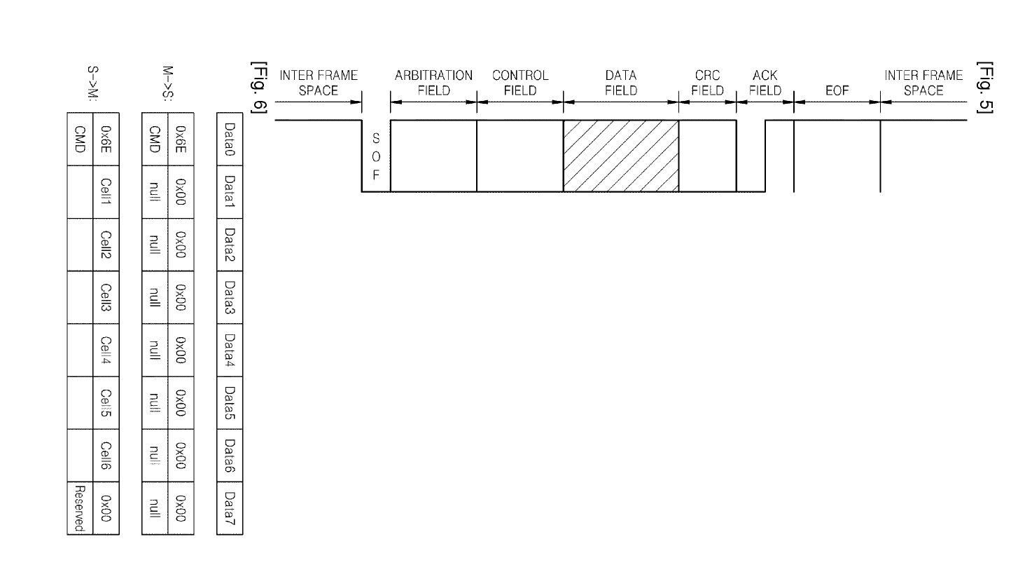

FIG. 4 is a block diagram of a communication system 300 having a master-slave structure.

Referring to FIG. 4, the communication system 300 includes a master 310, first through n-th slaves 320-1 through 320-n, and a third bus line 330.

The master 310 transmits a frame signal Cs including a command to the third bus line 330. The first through n-th slaves 320-1 through 320-n receive the frame signal Cs, and performs an operation corresponding to the command included in the frame signal Cs. Also, the first through n-th slaves 320-1 through 320-n respectively transmit frame signals D1 through Dn including data to the third bus line 330. Here, the first through n-th slaves 320-1 through 320-n may transmit the frame signals D1 through Dn to the master 310 at predetermined intervals so as to prevent data from colliding. Also, upon receiving the frame signals D1 through Dn, the master 310 performs a required process.

Here, the master 310 may correspond to the system controller 200 of FIG. 2, and the first through n-th slaves 320-1 through 320-n may correspond to the rack controller 230 of FIG. 2. Alternatively, the master 310 may correspond to the rack controller 230 of FIG. 3 and the first through n-th slaves 320-1 through 320-n may correspond to the tray controller 223 of FIG. 3.

A method of transmitting data performed by the communication system 300 having such a master-slave structure will now be described in detail.

FIG. 5 is a diagram of a frame structure of a CAN communication protocol. The CAN communication protocol is a communication protocol developed by Robert Bosch GmbH for car industries, and recently, is applied not only to car industries, but also to various industries. The CAN communication protocol is a serial network communication method using a multi-master message method defined at a rate of ISO 11898 Specification, which is known to those skilled in the art.

Referring to FIG. 5, a start of a message frame is indicated by “start of frame (SOF)”. Here, “SOF” is located at a top priority of the message frame, and has a dominant bit having a value of “0” as set by default.

“Arbitration Field” has an identifier and a remote transmission request (RTR) bit. Here, the RTR bit indicates whether the message frame is a data frame or a remote frame. If the message frame is a data frame for transmitting data, the RTR bit has a value of “0”. Alternatively, if the message frame is a remote frame for requesting to transmit data, the RTR bit has a recessive bit having a value of “1”.

“Control Field” is formed of 6 bits. Here, 2 bits are for a reserved domain, and the remaining 4 bits are for a data length code domain indicating a number of bytes of “Data Field”.

“Data Field” includes data to be transmitted from a data frame. A size of “Data Field” is from 0 to 8 bytes, wherein each byte includes 8 bits. Here, each byte of data is transmitted from a most significant bit (MSB).

“Cyclic Redundancy Code (CRC) Field” indicates a CRC. “CRC Field” includes ‘CRC Sequence’ and ‘CRC Delimiter’ having a value of “1”. “ACK Field” is formed of 2 bits, and includes ‘ACK Slot’ and ‘ACK Delimiter’. ‘ACK Slot’ constituting a first bit has a value of “0” and ‘ACK Delimiter’ constituting a second bit has a value of “1”. However, ‘ACK Slot’ may be recorded as a value of “1” transmitted from another node that successfully received a message.

“End of Frame (EOF)” is formed of 7 bits all having a value of “1”, and indicates that the message frame is ended.

“Interframe Space” includes ‘Intermission’ and ‘Bus Idle’, and classifies a previous or following message frame from a current message frame.

A structure of a data field in a transmitted data frame for preventing error generation while the master 310 and the first through n-th slaves 320-1 through 320-n communicate will now be described. For convenience of description, it is assumed that the master 310 transmits and receives data frames to and from the first slave 320-1.

Also, FIGS. 6 through 8 and FIG. 10 show a data field using a CAN communication protocol, but as described above, embodiments of the present invention are applicable to various communication protocols using a bus line. Accordingly, the data field does not have to be formed of 8 bytes, and may include x data sections. Also, each of the x data sections is not limited to 1 byte, and may have various sizes. Thus, a unit forming a data field will now be referred to as a ‘data section’.

FIG. 6 is a diagram of a data structure while transmitting data, according to an embodiment of the present invention. FIG. 6 shows data fields transmitted between the master 310 and the first slave 320-1 when an amount of data transmitted is small.

The master 310 requests the first slave 320-1 to transmit data. For this, the master 310 transmits a data frame after inserting a command CMD into one data section of a data field. Data sections of the data field other than the data section including the command CMD may be ‘null’.

The first slave 320-1 extracts the command CMD from the data frame received from the master 310, and transmits the data requested by the master 310 to the master 310. Here, according to the current embodiment, the data may be transmitted within one data field since the amount of data transmitted from the first slave 320-1 to the master 310 is small. Accordingly, a data frame is transmitted by inserting the command CMD transmitted from the master 310 into a first data section of a data field, and inserting the data to be transmitted into other data sections.

For example, assume that the master 310 is the rack controller 230 and the first slave 320-1 is the tray controller 223.

The rack controller 230 inserts a command CMD of ‘0x6E’ into a first data section, and transmits a data frame to the tray controller 223. For example, the command CMD may be a command to transmit voltage data of a battery cell.

If a voltage range of the battery cell is expressible by one data section, the tray controller 223 inserts ‘0x6E’, which is identical to the received command CMD, into a first data section of a data field, and sequentially inserts voltage values of the battery cell into other data sections. If a data section still remains after inserting all data, the remaining data section may be left as a spare.

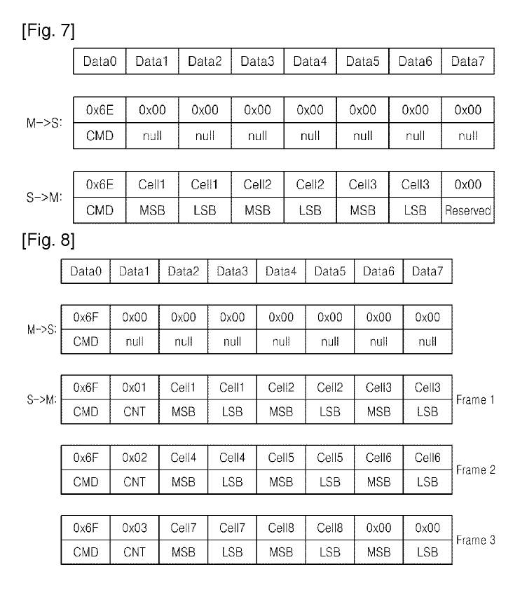

FIG. 7 is a diagram of a data structure while transmitting data, according to another embodiment of the present invention. FIG. 7 also shows a data field transmitted between the master 310 and the first slave 320-1 when an amount of data transmitted is small.

Like FIG. 6, the master 310 requests the first slave 320-1 to transmit data. The master 310 transmits a data frame after inserting a command CMD into one data section of a data field. Data sections of the data field other than the data section including the command CMD may be ‘null’.

The first slave 320-1 extracts the command CMD from the data frame received from the master 310, and transmits the data requested by the master 310 to the master 310. Here, according to the present embodiment, the data may be transmitted within one data field since the amount of data transmitted from the first slave 320-1 to the master 310 is small. Accordingly, a data frame is transmitted by inserting the command CMD transmitted from the master 310 into a first data section of a data field, and inserting the data to be transmitted into other data sections.

In the current embodiment, one data value is shown by adding two data sections. Like FIG. 6, assume that the master 310 is the rack controller 230 and the first slave 320-1 is the tray controller 223.

The rack controller 230 transmits a command to transmit voltage data of a battery cell to the tray controller 223. Since a voltage range of the battery cell is not expressible by one data section, in order to transmit data, the tray controller 223 transmits the voltage data of the battery cell by using two data sections. Accordingly, the tray controller 223 inserts ‘0x6E’ identical to a received command CMD to a first data section of a data field. Then, the tray controller 223 sequentially inserts voltage values of the battery cell by assigning two data sections for each battery cell in the other data sections. In other words, a voltage value of Cell 1 is inserted into second and third data sections (e.g., Data1 and Data2) and a voltage value of Cell 2 is inserted into fourth and fifth data sections (e.g., Data3 and Data4). If a data section still remains after inserting all data, the remaining data section may be left as a spare.

In the current embodiment an MSB value of a voltage value is inserted into a data section transmitted first and a least significant bit (LSB) value of the voltage value is inserted into a data section transmitted last, but this order may be changed.

FIG. 8 is a diagram of a data structure while transmitting data, according to another embodiment of the present invention. FIG. 8 shows data fields transmitted between the master 310 and the first slave 320-1 when an amount of data transmitted is large.

Like FIGS. 6 and 7, the master 310 transmits a data frame by inserting a command CMD into one data section of a data field (e.g., Data0).

The first slave 320-1 extracts the command CMD from the data frame received from the master 310, and transmits data requested by the master 310 to the master 310. Here, according to the current embodiment, all data cannot be transmitted in one data field since the amount of data transmitted from the first slave 320-1 to the master 310 is large. Accordingly, the data to be transmitted is divided into a plurality of data fragments, and the data fragments are transmitted by using a plurality of data frames.

The first slave 320-1 inserts the command CMD transmitted from the master 310 into a first data section of a data field and a counter CNT indicating an order of the data into a second data section of the data field, with respect to one data frame. Then, the first slave 320-1 inserts the data fragments into remaining data sections. As such, all data fragments may be transmitted by the plurality of data frames.

Then, assume that the master 310 is the rack controller 230 and the first slave 320-1 is the tray controller 223.

The rack controller 230 transmits a data frame to the tray controller 223 after inserting a command CMD of ‘0x6F’ into a first data section. For example, the command CMD may be a command to transmit temperature data of a battery cell. Here, the temperature data is expressed in two data sections. Also, the tray 222 includes a total of 8 battery cells.

The tray controller 223 inserts “0x6F”, which is identical to the received command CMD, into a first data section of a data field, and inserts a counter CNT indicating an order of data frames into a second data section. Since data is being inserted into a first data frame, ‘0x01’ is inserted. Then, the temperature data of cells 1 through 3 are sequentially inserted into remaining 6 data sections (e.g., Data2-Data7) to complete the data field of a first data frame Frame 1. A second data frame Frame 2 and a third data frame Frame 3 are generated in the same manner.

The tray controller 223 sequentially transmits the first through third data frames Frame 1 through Frame 3 to the rack controller 230. The rack controller 230 may extract the received data to update data about the battery cells.

Meanwhile, since embodiments of the present invention are about a data field of a data frame, the embodiments are applicable to both CAN 2.0A (i.e., a standard format), and CAN 2.0B (i.e., an extended format).

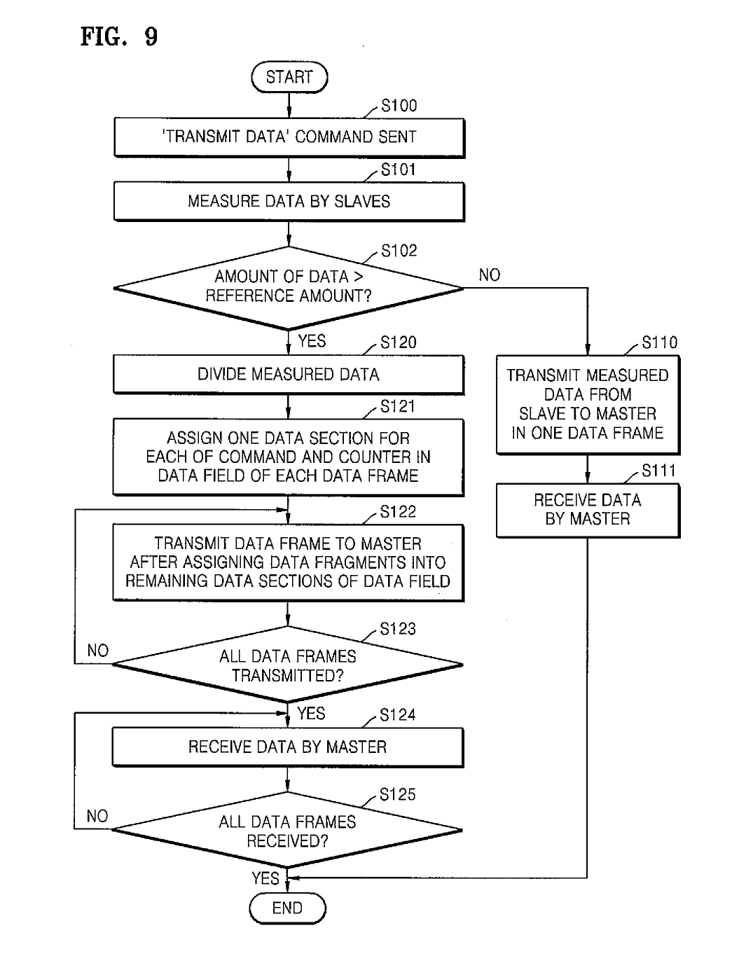

FIG. 9 is a flowchart illustrating a data transmitting method of the communication system 300, according to an embodiment of the present invention.

Referring to FIG. 9, the master 310 transmits a command to transmit data-to the first through n-th slaves 320-1 through 320-n in operation S100. The first through n-th slaves 320-1 through 320-n measure data in operation S101. Upon receiving the command from the master 310, the first through n-th slaves 320-1 through 320-n may measure data requested by the master 310, but alternatively, the first through n-th slaves 320-1 through 320-n may periodically monitor certain data and transmit obtained data upon receiving the command from the master 310.

The first through n-th slaves 320-1 through 320-n determine whether an amount of data to be transmitted is larger than a reference amount so as to transmit the data to the master 310, in operation S102. For example, it is determined whether the amount of data to be transmitted is larger than 7 bytes, in CAN communication. Here, 1 byte is assigned to the command CMD.

If the amount of data is smaller or equal to the reference amount, the first through n-th slaves 320-1 through 320-n insert the measured data into a data field of one data frame, and transmits the data frame to the master 310, in operation S110. The master 310 receives the data frame from the first through n-th slaves 320-1 through 320-n in operation S111.

Alternatively, if the amount of data is larger than the reference amount, the first through n-th slaves 320-1 through 320-n divide the measured data into data fragments in operation S120. A maximum size of each data fragment is identical to a size of data sections of the data field excluding two data sections.

The first through n-th slaves 320-1 through 320-n transmit all the data to the master 310 by transmitting a plurality of data frames. The first through n-th slaves 320-1 through 320-n assign one data section for each of a command CMD and a counter CNT in a data field of each data frame, in operation S121.

The first through n-th slaves 320-1 through 320-n insert the data fragments into remaining data sections of the data fields left after assigning the command CMD and the counter CNT, and transmit the data frames to the master 310, in operation S122. The first through n-th slaves 320-1 through 320-n determine whether all data frames are transmitted in operation S123 to determine whether all the data is transmitted to the master 310.

The master 310 receives the data frames from the first through n-th slaves 320-1 through 320-n in operation S124. The master 310 determines whether all data frames are received in operation S125 so as to receive all the data measured by the first through n-th slaves 320-1 through 320-n.

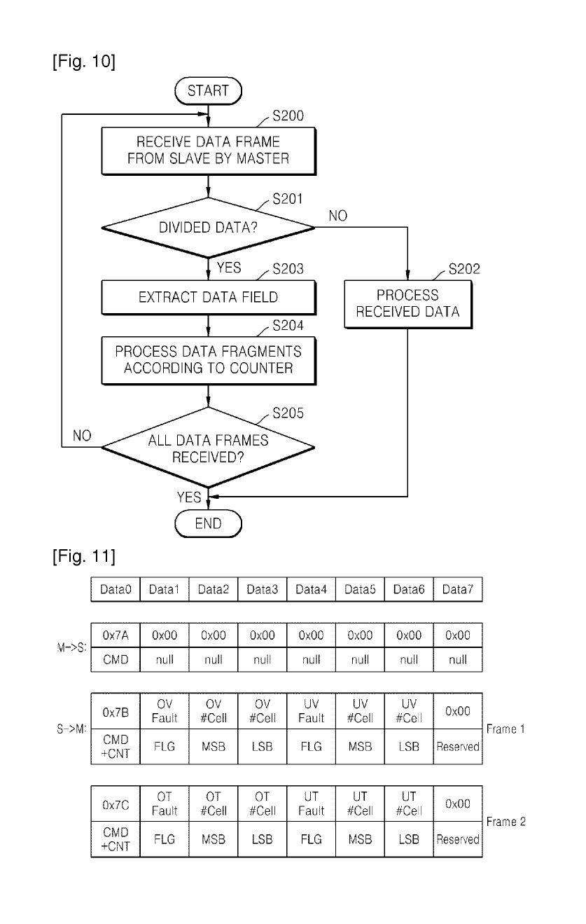

FIG. 10 is a flowchart illustrating operations of the master 310, according to an embodiment of the present invention.

Referring to FIG. 10, the master 310 receives a data frame including data from the first through n-th slaves 320-1 through 320-n in operation S200. The master 310 determines whether the data included in the data frame is one of a plurality of divided data fragments in operation S201.

If the received data is whole data, the master 310 processes the received data according to a corresponding command CMD in operation S202. For example, if the rack controller 230 requested voltage data of a battery cell from the tray controller 223, the rack controller 230 updates pre-stored voltage data of the battery cell to newly received voltage data by using the received data.

If the received data is one of a plurality of data fragments, the master 310 extracts a data field from the received data frame in operation S203. The master 310 processes the data fragment in operation S204 according to the command CMD and a counter CNT extracted from the data field. For example, if the rack controller 230 requested temperature data of a battery cell from the tray controller 223, the rack controller 230 updates pre-stored voltage data of the battery cell to new received voltage data by using the received data. However, data may be lost as data collides or similar errors occur in a communication protocol using a bus line. If data is lost, the master 310 may not be able to receive a certain data frame from among the data frames transmitted by the first through n-th slaves 320-1 through 320-n.

According to embodiments of the present invention, if an amount of data to be transmitted is large, the first through n-th slaves 320-1 through 320-n insert the counter CNT indicating an order of the data fragments with the data fragment in the data field. Accordingly, the master 310 is able to process the data fragments according to the counter CNT.

For example, referring to FIG. 8, assume that the rack controller 230 received the third data frame Frame 3 without receiving the second data frame Frame 2 from the tray controller 223. Since the data field of the third data frame Frame 3 includes a counter CNT indicating that a currently received data frame is the third data frame Frame 3, the rack controller 230 determines that a data fragment received with the third data frame Frame 3 is a third data fragment from among all the data. Accordingly, the rack controller 230 updates pre-stored temperature data of Cells 7 and 8 to received temperature data.

Then, the master 310 determines whether all data frames are received in operation S205, and if there is still a data frame to be received, operation S200 is performed. However, if all data frames are received, the operations of the master 310 are ended.

In the conventional art, the master 310 may not be able to determine whether one of data frames is not received, or whether an order of data frames received from the first through n-th slaves 320-1 through 320-n is changed. Accordingly, the master 310 may not accurately process received data. For example, referring to FIG. 8, in the conventional art, if the rack controller 230 received the third data frame Frame 3 and did not receive the second data frame Frame 2, the rack controller 230 may recognize the third data frame Frame 3 as the second data frame Frame 2. Accordingly, the master 310 determines received data fragments as data of Cells 4 and 5, despite receiving data fragments of the Cells 7 and 8. Thus, the master 310 updates pre-stored data of the Cells 4 and 5 with data of the Cells 7 and 8, and data of Cells 6 through 8 is not updated.

However, according to embodiments of the present invention, the master 310 is able to determine that the second data frame Frame 2 is lost. Thus, when the third data frame Frame 3 is received after skipping the second data frame Frame 2, the master 310 is able to update the data of the Cells 7 and 8 and skip the updating of the Cells 4 through 6. In other words, according to the embodiments of the present invention, an error is prevented while transmitting data.

FIG. 11 is a diagram of a data structure while transmitting data, according to another embodiment of the present invention. FIG. 11 shows data fields transmitted between the master 310 and the first slave 320-1 when an amount of data transmitted is large.

Like FIGS. 6 through 8, the master 310 transmits a data frame by inserting a command CMD into one data section of a data field.

The first slave 320-1 extracts the command CMD from the data frame received from the master 310, and transmits data requested by the master 310 to the master 310. Here, according to the current embodiment, all data cannot be transmitted in one data field since an amount of data to be transmitted from the first slave 320-1 to the master 310 is large. Accordingly, the data is divided into a plurality of data fragments, and the data fragments are transmitted by using a plurality of data frames.

Also, according to the present embodiment, the command CMD and a counter CNT are assigned to one data section. In the embodiment of the present invention depicted in FIG. 8, the command CMD and the counter CNT are respectively assigned to two data sections of a data field per frame. Thus, a number of data sections to be inserted with data to be actually transmitted is reduced. However, in the current embodiment, only one data section is assigned for the command CMD and the counter CNT, which are not actual data, and thus the number of data sections to be inserted with actual data is increased.

However, a number of commands CMD and an amount of data must satisfy certain conditions so as to assign one data section for the command CMD and the counter CNT because if the number of commands CMD is above a number expressible by one data section, the counter CNT cannot be inserted into the same data section as the command CMD. Thus, the numbers of commands CMD and counters CNT must satisfy a predetermined standard according to a number of bits assigned to one data section. For example, the data field may be configured according to the current embodiment in CAN communication, when the number of commands CMD is less than or equal to 64, and a number of frames required to transmit all data is less than or equal to 4. In detail, upper 6 bits may indicate a command CMD, and lower 2 bits may indicate a counter CNT in one data section.

Then, the data fragments are inserted into remaining data sections. As such, the data fragments may be transmitted by the data frames.

For the purposes of illustration, assume that the master 310 is the rack controller 230 and the first slave 320-1 is the tray controller 223.

The rack controller 230 inserts a command CMD of ‘0x7A’ into a first data section of a data field and transmits a data frame to the tray controller 223. For example, the command CMD may be a command to transmit data about a state of a battery cell, such as data about an abnormal voltage or temperature.

The tray controller 223 inserts ‘0x7B’, which is obtained by adding ‘0x01’ as a counter CNT indicating a first data frame Frame 1 to ‘0x7A’ and is identical to the received command CMD, into the first data section of the data field. Since the rack controller 230 corresponding to the master 310 is able to determine the command CMD, the rack controller 230 is able to extract the counter CNT from the first data section of the received data frame.

Then, the data about the state of the battery cell is inserted starting from a second data section. Referring to FIG. 11 in detail, the tray controller 223 inserts an over voltage state flag (OV Fault) of the battery cell, the number of over voltage battery cell (OV #Cell), an under voltage state flag (UV Fault) of the battery cell, and the number of under voltage battery cell (UV #Cell) into the data field, and transmits the data field to the rack controller 230. Here, two data sections are assigned respectively for the OV #Cell and the UV #Cell. Also, a last data section is left as a spare region.

After transmitting first data frame Frame 1 related to over voltage and under voltage, which corresponds to a first data fragment, the tray controller 223 forms a data field to transmit a second data frame Frame 2.

Like the first data frame Frame 1, the tray controller 223 inserts ‘0x7C’, which is obtained by adding ‘0x02’ as a counter CNT indicating a second data frame Frame 2 to ‘0x7A’ and is identical to the received command CMD, into a first data section of the data field.

Then, data about the state of the battery cell is inserted starting from a second data section. In detail, the tray controller 223 inserts an over temperature state flag (OT Fault) of the battery cell, the number of over temperature battery cell (OT #Cell), an under temperature state flag (UT Fault) of the battery cell, and the number of under temperature battery cell (UT #Cell), which are remaining data fragments, into the data field, and transmits the data field to the rack controller 230. Here, two data sections are assigned respectively for the OT #Cell and the UT #Cell.

The rack controller 230 may update data about the battery cell by extracting the received data.

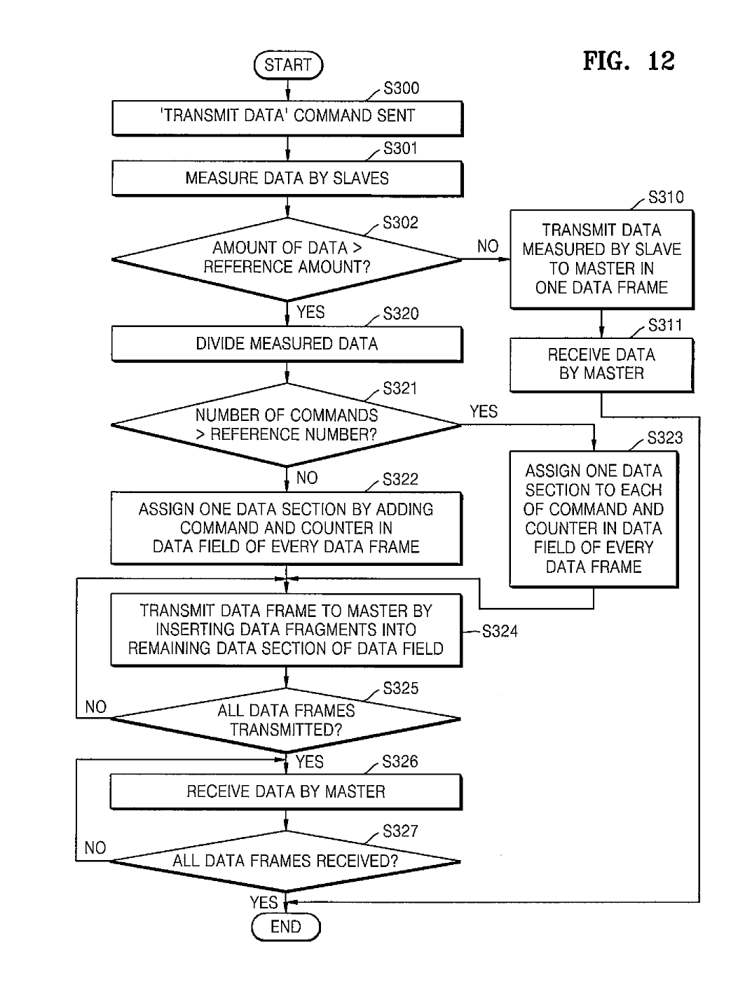

FIG. 12 is a flowchart illustrating a data transmitting method of the communication system 300, according to another embodiment of the present invention.

Referring to FIG. 12, the master 310 transmits a command to transmit data to the first through n-th slaves 320-1 through 320-n in operation S300. The first through n-th slaves 320-1 through 320-n measure data in operation S301. The first through n-th slaves 320-1 through 320-n may measure data requested by the master 310 after receiving the command from the master 310, or alternatively, the first through n-th slaves 320-1 through 320-n may periodically monitor certain data, and may transmit stored data upon receiving the command from the master 310.

The first through n-th slaves 320-1 through 320-n determine whether an amount of data to be transmitted is larger than a reference amount so as to transmit the data to the master 310 in operation S302. For example, it is determined whether the amount is larger than 7 bytes in CAN communication. Here, 1 byte is assigned to a command CMD.

If the amount is smaller than or equal to the reference amount, the first through n-th slaves 320-1 through 320-n insert the measured data into a data field of one data frame, and transmits the data frame to the master 310 in operation S310. The master 310 receives the data frame from the first through n-th slaves 320-1 through 320-n in operation S311.

Alternatively, if the amount is larger than the reference amount, the first through n-th slaves 320-1 through 320-n divide the measured data into data fragments in operation S320. Then, it is determined whether a number of commands CMD is higher than a reference number in operation S321. Here, not only the number of commands CMD, but also a number of required data frames may be determined.

Since details thereof are described above with reference to FIG. 11, the details will not be repeated herein.

If the number of commands CMD is higher than the reference number, operations S323 through S327, which are respectively identical to operations S121 through S125 of FIG. 9, are performed. In other words, if both a command CMD and a counter CNT cannot be inserted into one data section, one data section is assigned for each of the command CMD and the counter CNT in operation S323.

Alternatively, if the number of commands CMD is less than or equal to the reference number, the first through n-th slaves 320-1 through 320-n assign a command CMD and a counter CNT, which are assigned to one data section by adding the command CMD and the counter CNT in a data field of each data frame, in operation S322.

Then, the first through n-th slaves 320-1 through 320-n insert the data fragments into data sections of the data fields left after assigning the commands CMD and the counters CNT, and transmit each data frame to the master 310 until all data frames are transmitted in operations S324 through S327.

As described above, according to the embodiments of the present invention, an error generation due to data loss can be prevented while the communication system 300 having the master-slave structure or the battery system 20 transmits data by using a bus line. Also, in the energy storage system 1 using the large capacity battery system 20, an error generation due to data loss can be prevented while data is transmitted from the tray controller 223 to the rack controller 230, or from the rack controller 230 to the system controller 200.

The particular implementations shown and described herein are illustrative examples of the invention and are not intended to otherwise limit the scope of the invention in any way. For the sake of brevity, conventional electronics, control systems, software development, and other functional aspects of the systems (and components of the individual operating components of the systems) might not be described in detail. Furthermore, the connecting lines or connectors shown in the various figures presented are intended to represent exemplary functional relationships and/or physical or logical couplings between the various elements. It should be noted that many alternative or additional functional relationships, physical connections, or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention, and does not pose a limitation on the scope of the invention unless otherwise claimed. Numerous modifications and adaptations will be readily apparent to those skilled in this art without departing from the spirit and scope of the present invention.

1. An energy storage system configured to be coupled to at least one of a power generation system, a grid, or a load, the energy storage system comprising:
a battery system comprising:
a system bus;
a system controller coupled to the system bus and configured to transmit one or more first system frames on the system bus, each of the first system frames comprising a command; and
one or more battery racks coupled to the system bus and configured to transmit one or more second system frames on the system bus, wherein at least one of the one or more battery racks comprises:
a rack for storing power; and
a rack controller for receiving rack data, and for transmitting the one or more second system frames including the rack data on the system bus, each of the second system frames comprising the command and at least a portion of the rack data,
wherein at least one of the one or more second system frames further comprises a second system frame counter.

2. The energy storage system of claim 1, wherein when a size of the rack data is larger than a system frame reference size, the rack data is divided and included in two or more of the second system frames.

3. The energy storage system of claim 1, wherein the system controller is configured to operate as a master on the system bus, and the rack controller is configured to operate as a slave on the system bus.

4. The energy storage system of claim 3, wherein the system controller is configured to command transmission of the rack data to the rack controller by transmitting at least one of the first system frames on the system bus.

5. The energy storage system of claim 4, wherein the rack controller is configured to transmit the rack data to the system controller by transmitting one or more of the second system frames on the system bus.

6. The energy storage system of claim 1, wherein a communication protocol between the system controller and the rack controller of the at least one of the one or more battery racks is a controller area network (CAN) protocol.

7. The energy storage system of claim 1, wherein the at least one of the one or more battery racks further comprises:
a rack bus; and
one or more battery trays for storing the power, at least one of the one or more battery trays being coupled to the rack controller through the rack bus.

8. The energy storage system of claim 7, wherein the at least one of the one or more battery trays comprises:
a tray comprising one or more battery cells for storing the power; and
a tray controller for controlling charging and discharging operations of the tray and for transmitting to the rack controller tray data comprising at least one of a measured temperature, a measured voltage, or a measured current of the one or more battery cells.

9. The energy storage system of claim 8, wherein the rack controller is configured to operate as a master on the rack bus, and the tray controller is configured to operate as a slave on the rack bus.

10. The energy storage system of claim 9, wherein the rack controller is configured to transmit one or more first rack frames on the rack bus, and the tray controller is configured to transmit one or more second rack frames on the rack bus.

11. The energy storage system of claim 10, wherein the rack controller is configured to command transmission of the tray data to the tray controller by transmitting at least one of the first rack frames comprising a command on the rack bus.

12. The energy storage system of claim 11, wherein the tray controller is configured to transmit the tray data to the rack controller by transmitting one or more of the second rack frames on the rack bus, each of the second rack frames comprising the command and at least a portion of the tray data, and
wherein at least one of the one or more second rack frames further comprises a second rack frame counter.

13. The energy storage system of claim 12, wherein when a size of the tray data is larger than a rack frame reference size, the tray data is divided and included in two or more of the second rack frames.

14. The energy storage system of claim 8, wherein a communication protocol between the rack controller and the tray controller of the at least one of the one or more battery trays is a controller area network (CAN) protocol.

15. A battery rack comprising:
a rack for storing power;
a rack bus; and
a rack controller coupled to the rack bus and configured to transmit one or more command frames on the rack bus, each of the command frames comprising a command,
wherein the rack comprises one or more battery trays for storing the power, at least one of the one or more battery trays comprising:
a tray comprising one or more battery cells for storing the power; and
a tray controller coupled to the rack bus and configured to transmit to the rack controller one or more data frames comprising tray data comprising at least one of a measured temperature, a measured voltage, or a measured current of the one or more battery cells,
wherein at least one of the data frames further comprises a data frame counter.

16. The battery rack of claim 15, wherein when a size of the tray data is larger than a rack frame reference size, the tray data is divided and included in two or more of the data frames.

17. The battery rack of claim 15, wherein the rack controller is configured to operate as a master on the rack bus, and the tray controller is configured to operate as a slave on the rack bus.

18. The battery rack of claim 17, wherein the rack controller is configured to command the tray controller to transmit the tray data by transmitting one or more command frames comprising a command on the rack bus.

19. The battery rack of claim 18, wherein the tray controller is configured to transmit the tray data to the rack controller by transmitting one or more data frames comprising the command and the tray data on the rack bus.

20. A communication system for an energy storage system, the communication system having a master-slave structure and comprising:
a system bus;
a master for transmitting on the system bus a command frame comprising a command, and for performing processing corresponding to data frames comprising the command and energy storage system data; and
a plurality of slaves for receiving the command frame from the system bus, for performing an operation corresponding to the command in the command frame, and for transmitting the data frames on the system bus,
wherein at least one of the data frames further comprises a data frame counter.

21-23. (canceled)
